(19) United States
(12) Patent Application Publication
(10) Pub. No.: US 2009/0192860 A1
(43) Pub. Date: Jul. 30, 2009

(54) System and Method for Managing Business Partnerships as they Evolve Across all Aspects of the Content Creation and Advertising Value Chain

(76) Inventors: Jonathan Heller, San Francisco, CA (US); Jingchun Diane Yu, Palo Alto, CA (US); Michael Henry Evangelista, Metuchen, NJ (US)

Correspondence Address: GLENN PATENT GROUP, 3475 EDISON WAY, SUITE L, MENLO PARK, CA, 94025, US

(21) Appl. No.: 12/357,228

(22) Filed: Jan. 21, 2009

Related U.S. Application Data
(60) Provisional application No. 61/024,175, filed on Jan. 28, 2008.

(51) Int. Cl. G06Q 10/00; G06Q 30/00

(52) U.S. Cl. 705/8; 705/1; 705/14

(57) ABSTRACT

The present invention relates to managing a multi-directional advertising value chain and effectively managing a very large number of partnerships where each partner can, over time, fulfill any and all of the piece of that value chain simultaneously. According to the present invention, tracking, accounting, controlling and netting out of compensation for the various pieces of the is flexible enough to dynamically adjust any piece of the advertising value chain as business relationships evolve.

### CROSS-REFERENCE TO RELATED APPLICATIONS

This application claims priority to U.S. Provisional Patent Application No. 61/024,175 filed 28 Jan. 2008.

### BACKGROUND OF THE INVENTION

1. Technical Field

The present invention relates to managing business partnerships in the fields of digital content creation and advertising. More specifically, the present invention relates to managing a multi-directional content creation/advertising value chain; effectively managing a very large number of partnerships within the value chain; and tracking the rights and restrictions for the partners within the value chain.

2. Description of the Related Art

The propagation of media to consumers has long provided an opportunity for businesses to reach consumers of the media with advertisements. For example, broadcast media outlets originated with a model of providing consumers with access to content by selling advertisement slots with the broadcast content.

The internet has become a vital part of many people's lives. With the rapid growth of the Internet, the model for distribution of media content has experienced significant changes to the traditional broadcast paradigm. For instance, media consumers have a much wider variety of options to choose from when looking for media content. For example, content is now available through many new outlets such as video on demand, file sharing, instant paid media downloads and streaming video to name a few. Likewise, consumption of media has become mobile with the widespread use of personal video players, PDA/smartphones and the like. Additionally, as media is syndicated to a growing number of outlets, the actual content has become the draw for consumers, not the portal through which it is viewed.

Despite these changes in distribution and consumption, the model for monetization of content through advertising still follows a basic value chain. The first step is the creation of content. Next, the content is displayed and promoted to build an audience. Finally, businesses sell advertisement against that audience.

In fact, this basic model of providing content to an audience and selling advertisement opportunities to businesses to reach that audience has prevailed as the primary method for monetization of digital content over the Internet.

Internet advertising is a world of interconnected business entities and partnerships. In the early stages of the Internet up through the advent of online video and widgets, these business relationships were predominantly focused on separate components of the advertising value chain. For example, the most simple value chain exists when a single company fulfills all roles as follows: Company X creates content or acquires rights to content; Company X displays content on a website and creates an audience and advertising opportunities; and finally Company X sells that advertising.

A standard relationship exists when there are two companies and each provides a separate role. For example: Company X creates content or acquires rights to content; Company X then displays content on a website and creates an audience and advertising opportunities; finally Company Y sells that advertising and pays Company X a share of the profit. Or similarly: Company X creates or acquires the rights to content; Company Y then secures limited rights to that content; Company Y displays that content, creating an audience and advertising inventory; and finally, Company Y then sold the advertising but kept the revenue since they'd already sub-licensed the content from Company X.

Traditionally, companies more or less specialized in one part of the value chain;
Studios or production companies created content
Networks and Studios sourced content and secured the rights to content
Distribution companies and cable carriers brought content to the consumer
All three, plus possibly ad rep firms, sold ads

In these examples, one company is filling a particular piece of the advertising value chain at any one time. While any one company may be filling any piece of the value chain with any other company, each piece of the value chain is being fulfilled by ONE of the partner companies (i.e. either Company X or Company Y is creating the content; either Company X or Company Y is displaying and building audience; and either Company X or Company Y is selling the ads into that audience.) This type of relationship exists because the direction of flow of this value chain has been unidirectional in advertising. So, while all combinations of above have been practiced, they are nearly always in a relatively simple structure to manage because one Company is doing one part of the value chain and another is doing another. According to these models, managing who is allowed to sell or display and who is due what compensation for the piece of the value that has been created is relatively straight forward. If Company Y sold ads on behalf of Company X, Company Y pays Company X some fee from the revenues Company Y produced.

However, with the advent of online video and super syndication, the forms of business relationships between parties along the advertising value chain have become more complex. For instance, it is very possible for multiple companies to be fulfilling the same piece of the value chain to each other in parallel. For example, Company X can be providing content to Company Y while at the same time Company Y can be doing so for Company X. Furthermore, Company X can be selling on behalf of Company Y and vice versa. This is because the pieces of the advertising value chain have fragmented with the onset of content syndication across many partners. Therefore, it is now possible for any two companies to be fulfilling any combination of all three pieces of the advertising value chain to each other. In fact, the actors in the advertising chain change very frequently. In some cases, the combination of companies change each time a video is served. Additionally, the roles fulfilled by the dynamic combinations of partnerships also reconfigure and recombine in all possible permutations, video by video, impression by impression.

In the realm of online video syndication any one business partner may actually fulfill different roles in the video and advertisement delivery value chain, for example:
A video portal may both distribute content AND sell ads (i.e. YouTube or MSN)
An ad network may both distribute content AND sell ads (i.e. Fifth Network or Videoegg)
A content creator may also want to control ads in their own content (i.e. NFL or MLB)

What makes online video especially complex, is that the partner that fulfills a particular role in the value chain may actually change with every single impression on every single video play.

Considering the new possible value chain models, when multiplied across the number of business partnerships necessary in online and television syndication, the complexity of tracking who is allowed to do what and who is due what compensation for having produced that piece of value grows exponentially. For instance, tracking these rights and controls and netting out compensation due is no longer feasible with the ‘unidirectional value chain’ flows of the existing ad management and advertising accounting systems and methods. Also, the timing of when any particular business partner takes on a new piece of the advertising value chain for any particular other company adds to this complexity. Furthermore, the previously negotiated terms for the relationship with each business partner must evolve to fit the new role they are fulfilling.

Existing internet, digital and traditional media ad management systems are ‘unidirectional’ in the value chain flow and can only accommodate each company filling any one piece in the relationship at any one time. This essentially makes it operationally complex, costly and potentially infeasible to manage a large number of business relationships across a widely syndicated network of business partners when all are providing content, advertising sales relationships and distribution relationships in many combinations.

All of these variables and possible permutations result in a staggering amount of calculation. However, accurate record keeping is critical to provide the various partners with an accounting for their share of revenues derived from the delivery of media. Therefore, there is a need for a business partnership management system that is configured to track the partners' actions relating to the various pieces of a content value chain as the value chain dynamically re-compiles into different combinations of partners fulfilling the various roles.

### SUMMARY OF THE INVENTION

The present invention provides a system of managing a multi-directional advertising value chain and effectively managing a very large number of partnerships where each partner can, over time, fulfill any and all of the piece of that value chain simultaneously. In some embodiments the various permutations of partners fulfilling the various roles in a value chain change between each individual play of a media asset. In fact, it is likely that the various permutations will shift and recombine and occur over and over ever single time someone hits “Play”. Due to this level of frequency of change, a high degree of automation is required to account for the various roles to keep track of which partner is due what amount of revenue.

According to the present invention, a system provides users a method of tracking, accounting, controlling and netting out of compensation for the various pieces of the value chain. Furthermore, the system is flexible enough to ‘add and subtract’ any piece of the advertising value chain as business relationships evolve. In this environment, a system administrator, analyst or any other user is able to observe, track and record what partner is owed what piece of the monetization rights for every instance that an advertisement is served.

In the preferred of the present invention, the actual content is the central item in the ad selection and tracking logic of the Value Chain Management system. According to these embodiments, it is easy to track: which partner created the content and/or owns the content, whether a partner has licensed the content, where the content was actually viewed, and who sold the ad that accompanied the content when it was actually viewed. These events are tracked each and every time an ad is served, thus rights to revenue and any restrictions that must be enforced between the parties involved are dynamically apportioned.

The present invention also comprises a method of managing an evolving advertising business partnership. The evolving partnership is preferably an online video delivery/advertising partnership. However, it will be readily apparent to those having ordinary skill in the art having benefit of this disclosure that the partnership may involve content delivery via Video on Demand (VOD) applications, dynamic television, as well as other content delivery application now known or later developed. This is accomplished by establishing a business partnership comprising one or more business partner. Each partner provides one or more role of the value chain. The method is further accomplished by establishing a managing business partner to manage the partnership as it evolves by memorializing various business arrangements in a Value Chain software application and providing an accounting relating to what parties fulfill the various roles and what revenue rights are due to whom. Preferably, the managing business partner manages the partnership through the steps of: memorializing which partners have the right to sell a unit of advertisement inventory; separately determining rights to revenue to compensate the partners for their individual roles within the value chain, and dynamically adjusting the rights to revenue as at least one of the partners provides a new role.

In some embodiments of the present invention, a Value Chain Management system is provided with a unique Graphical User Interface (GUI). According to these embodiments, the user is easily able to manage the roles of the various partners, manage the restrictions and controls of the partners, track the monetization rights due to the various partners, and provide an instantaneous accounting, among other capabilities.

In some embodiments of the present invention, the system of managing a multi-directional advertising value chain as described herein is performed by a central node within an enterprise architecture. In some embodiments, the system of the present invention is embedded in hardware found on a server. In some embodiments, the system of the present invention is embedded on a computer readable medium configured to be read by a computer within the enterprise. In some embodiments, the system of the present invention is provided in executable form on a stand-alone hardware module configured to couple with a computer within the enterprise. In the preferred embodiment of the present invention, the system of managing a multi-directional advertising value chain comprises a hosted and application available to one or more of the business partners.

### BRIEF DESCRIPTION OF THE DRAWINGS

FIG. 1 illustrates a visual representation of an exemplary partnership relationship according to some embodiments of the present invention.

FIG. 2A illustrates a visual representation of an exemplary partnership relationship with a managing partner utilizing the value chain management system according to some embodiments of the present invention.

FIG. 2B illustrates a visual representation of an evolving partnership relationship with a managing partner utilizing the value chain management system according to some embodiments of the present invention

FIG. 3A illustrates an example of a graphical user interface provided to a managing partner according to some embodiments of the present invention.

FIG. 3B illustrates another exemplary graphical user interface as experienced by a managing partner according to some embodiments of the present invention.

FIG. 3B illustrates another exemplary graphical user interface as experienced by a managing partner according to some embodiments of the present invention.

FIG. 3D illustrates a graphical user interface as presented to a managing partner attempting to change Ad Ratings settings.

### DETAILED DESCRIPTION OF THE INVENTION

Those of ordinary skill in the art will realize that the following detailed description of the present invention is illustrative only and is not intended to limit the claimed invention. Other embodiments of the present invention will readily suggest themselves to such skilled persons having the benefit of this disclosure. It will be appreciated that in the development of any such actual implementation, numerous implementation-specific decisions must be made in order to achieve the developer's specific goals. Reference will now be made in detail to implementations of the present invention as illustrated in the accompanying drawings. The same reference indicators will be used throughout the drawings and the following detailed description to refer to the same or like parts.

The invention relates to evolving partnerships and the need to dynamically manage the rights to and the controls over digital content in the fields of advertising and distribution of digital content. The invention solves the problem of a multi-directional advertising value chain and effectively managing a very large number of partnerships where each partner can, over time, fulfill any and all of the piece of that value chain simultaneously. A present preferred embodiment of the invention includes Value Chain Management software stored on a computer-readable medium and a graphical user interface for presenting the software to a user.

Value from digital content is most often derived from the sale of advertising displayed or otherwise published to an audience along with the content. The process of monetizing digital content follows a basic value chain including the creation of content, the optional licensing of the content, the distribution of the content to an audience and the sale of advertisement against that content.

For the purpose of this disclosure, the term “value chain” shall mean the process of transforming content into revenue by one or more business partners through distributing the content to an audience and selling advertisement slots within the content to sponsors such that the consuming audience is served with that advertisement.

Likewise, for the purpose of this disclosure, the phrases “right to revenue”, rights to revenue” and “revenue rights” shall mean the amount(s) of money owed to a particular partner or partners within a value chain for fulfilling one or more role within that value chain. Preferably, negotiated deals are agreed upon between the partners beforehand such that revenue rights vest upon a media asset being served.

Also, for the purpose of this disclosure, the term “managing partner” shall be used to identify the one or more partner that actually utilizes the system for tracking the value chain according to some embodiments of the present invention. The managing partner may or may not actually have a “managerial” role in terms of being senior to one or more of the other partners. Instead the managing partner simply asserts control over/manages the assignment of roles, controls, rights to revenue, etc. for the value chain.

As explained above, it is very possible for multiple companies to be fulfilling the same piece of the value chain to each other in parallel. For example, Company X can be providing content to Company Y while at the same time Company Y can be doing so for Company X. Additionally, the roles fulfilled by the dynamic combinations of partnerships also reconfigure and recombine in all possible permutations, video by video, impression by impression. As such, Company X can be selling advertisement on behalf of Company Y and vice versa. This is because the pieces of the advertising value chain have fragmented with the onset of content syndication across many partners. Therefore, it is now possible for any two companies to be fulfilling any combination of all three pieces of the advertising value chain to each other.

In a more pressing example, for a first instance, company X fills two of the four pieces of the value chain. In other separate instances, company X fulfils three of the four pieces of the value chain, one of the four, or even none of the pieces of the value chain. In the real life market, these combinations and other like it occur simultaneously in huge volumes, often as much as billions of times daily.

To illustrate the multi-party nature of an evolving value chain, consider the hypothetical examples below using real life entities. In all of the following examples, a user watches a digital video with advertisement inserted therein.
Example #1: Suppose the user watches the program “CSI” on the Internet site http://www.veoh.com/. The producer of the program, Jerry Bruckheimer created the content, the television network CBS owns the rights to the program, the operators of http://www.veoh.com/ caused the viewing of the program, and CBS sold the advertisements inserted into the file.
Example #2: Suppose the user watches the program “CSI” on the network CBS. The producer of the program, Jerry Bruckheimer created the content, the television network CBS owns the rights to the program, CBS caused the viewing of the program, and CBS sold the advertisements inserted into the file.
Example #3: Suppose the user watches the program “CSI” on the Internet site http://www.bebo.com/. The producer of the program, Jerry Bruckheimer created the content, the television network CBS owns the rights to the program, the operators of http://www.bebo.com/ caused the viewing of the program, and also suppose that the operators of http://www.bebo.com/ sold the advertisements inserted into the file.
Example #4: Suppose now that the operators of http://www.bebo.com/ sells CBS unused content from their library. The operators of http://www.bebo.com/ created the content, and own the rights to the content. Suppose that CBS causes the viewing and also sold the advertisement.
Example #5: Suppose that the operators of http://www.bebo.com/ embeds a media player on the CBS site. Now suppose that the operators of http://www.bebo.com/ created the content and own the rights to the content, CBS causes the viewing and the operators of http://www.ad.com/ sold the advertisement.

Clearly accurate accounting is needed due to the complexity of calculations, the dynamic nature of the systems, and the sheer number of reconfigurations that occur in the value chain. However, accurate tracking of the relationships between the various parties, the various duties and the rights to get paid for fulfilling the various roles becomes computationally complicated as the roles begin to be fulfilled by dynamic combinations of partnerships. The system and method of the present invention solves problems associated with such a multi-directional and dynamically compiling advertising value chain. The system and method of the present invention also provides an efficient method of managing a very large number of partnerships where each partner can, over time, fulfill any and all of the piece of that value chain simultaneously.

In some embodiments of the present invention, the process of accounting for the dynamic recompilation and reconfiguration of a Value Chain for an evolving group of partners involves a highly complex calculation that is automated and executed at scale (discussed below).

In some embodiments, the calculation is an algorithmic calculation optimizing rights to revenue, rights to sell ads, revenue shares, time windows during which rights are active and the nature of the particular content item in question, all combined to optimize the revenue and profit of the rights holder of the content. According to these embodiments, the calculation is performed across millions of content items, billions to trillions of times consumed, and tens of thousands of partners in various permutations of roles that vary with each impression. According to the present invention these transactions are optimized, by accurate accounting and happen within milliseconds.

The apparatus, system and method of the present invention are configured to manage partnership relationships between two or more entities and are also configured to assign roles to the various partners. The roles available are selected from among all the parts of value chain of digital content. Preferably, the roles are selected from among, providing content, displaying the content (providing an audience) and selling advertisements against the content. The present invention also tracks the revenue rights depending on what partner fulfilled what part of the value chain. Preferably, the revenue rights are determined for each instance that a particular piece of content is actually served to a consumer. Furthermore, according to some embodiments of the invention the system is configured to dynamically assign and define a number of rights, restrictions, and controls over content.

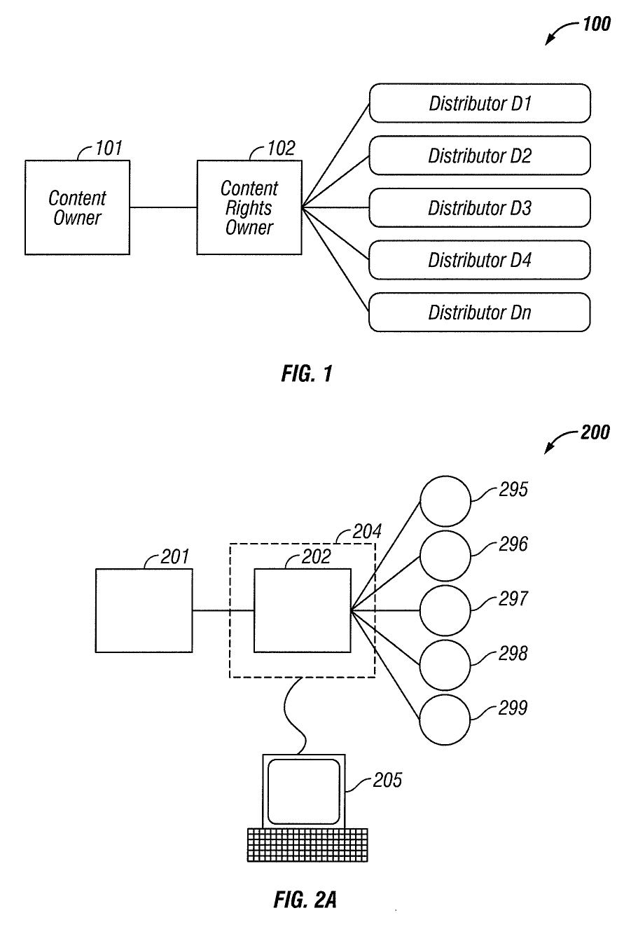

FIG. 1 illustrates a visual representation of an exemplary partnership relationship according to some embodiments of the present invention. FIG. 1 shows a partnership 100 comprising partners including a content owner 101, a content rights owner 102 and distributors D1, D2, D3, D4, . . . , Dn. In a typical scenario, the content owner 101 creates content that is attractive to an online audience. For example, the content owner may create a digital video. A content rights owner 102 then acquires the rights to the content by entering into a contractual relationship with the content owner 101. Next, the content rights owner 102 distributes the content through one or more distributors D1, D2, D3, D4, . . . , Dn. Finally, advertisement space is sold to advertisers such that an audience of the content will consume the advertisement.

Various business arraignments exist for determining what partner sells the advertisements and how. Furthermore, the amount that each party gets paid depends on which party created the delivered content, who owns the rights to the delivered content, who sold the advertising, and which party actually delivers the content to a consumer. In some embodiments, various other factors may influence revenue rights. According to some embodiments of the invention, the particular relationship between the partners is negotiated beforehand and subsequently memorialized by the Value Chain Management system of the present invention. After the terms are entered, the Value Chain Management system tracks revenue rights based on these terms as the partnership combinations dynamically change with each play of each delivery of a media asset.

For example, suppose a particular content owner 101 has an agreement with a content rights owner 102 which dictates that the content owner 101 will receive twenty percent (20%) of any advertising revenue sold against that content. The content rights owner 102 may then make various agreements with distributors D1, D2, D3, D4, . . . , Dn to distribute the content to an audience and also may make an agreement with an advertiser to place advertisements in the content. Suppose that the content rights owner agrees to pay on particular distributor, D3, thirty percent (30%) of the advertising revenue every time a user actually views the content through that particular distributor, D3. According to this example, the advertiser will pay the content rights owner 102 a sum of money for facilitating the viewing of their advertisement by an end viewer. The content rights owner 102 then pays the content owner 101 twenty percent (20%) and the distributor D3 thirty percent (30%) of the advertisement revenue.

FIG. 1 illustrates an extremely simple case of content distribution and monetization. However, as explained above, in today's market of super syndication and sophisticated online business arrangements, the roles played by the various parties can quickly evolve. In fact, the partnership roles played by the various parties are recombined and reconfigured into all permutations for each media asset delivery, up to billions of times per day. Furthermore, in some embodiments, the rules relating to selling advertisements and the monetization rights are equally dynamic. Clearly it would be useful to provide a system and method of automating these processes and provide an accounting method to track the complex arrangements.

For example, suppose that instead of the content rights owner 102 selling the advertisement, the distributor D3 sells the advertisement. Clearly, the amount paid to the distributor should increase. Also, suppose now that a distributor D1 obtains the rights to some other content that the content rights owner 102 wishes to distribute through one or more of the other distributors D2, D3, D4, . . . Dn. The distributor D1 now steps into the role of a content owner. As such, the amount owned to D1 changes for the viewings of the content they acquired.

Therefore it is an object of the present invention to manage the evolving partnerships present in contemporary online media distribution. Likewise, it is an object of the invention to dynamically encode and enforce restrictions and controls associated with the media content each time it actually served (which can be up to billions of times per day). Also, it is a key object of the present invention to track the evolving partnerships and provide an accounting showing the revenue rights for the various partners within the value chain. In fact, in the preferred embodiment of the present invention, the amount of money paid to each partner is re-evaluated each time a piece of content is actually consumed and a user is exposed to one or more advertisements through one or more ad slots.

Also, in the preferred embodiments of the invention, Value Chain Management software is provided to manage the evolution and dynamic recombination of rights and accounting for digital content distribution and advertising between the partners. A present preferred embodiment of the invention includes Value Chain Management software stored on a computer-readable medium and a graphical user interface for presenting the software to a user.

For the purpose of this disclosure, the one or more partner that actually utilizes the software will be referred to as the managing partner (as defined above). The managing partner may or may not actually have a “manager” role in terms of being senior to one or more of the other partners. Instead the managing partner simply obtains control over the assignment of roles, controls, etc for the value chain. In fact, as explained above, the actual business negotiations between partners are conducted away from the system and are subsequently memorialized via the software.

In some embodiments of the present invention, the various partners negotiate deals relating to what party is responsible for the various roles in the value chain and how much or what percent of the advertisement revue they receive if when an ad is actually served. Then, through the Value Chain Management software, the managing partner dynamically assigns and/or alters the roles of the various partners, alters the rights to sell advertising, alters the restrictions and controls (explained below) and/or alters the compensation schemes for the various partners. The Value Chain Management software tracks when the dynamically decided ads are actually served and tracks which party contributed to what role. As explained above, the Value Chain Management software is configured to perform a staggering amount of calculations to handle up to billions of ad plays and media plays per day. Every time an advertisement is actually served, the Value Chain Management software, automatically allocates monetization rights to the various partners.

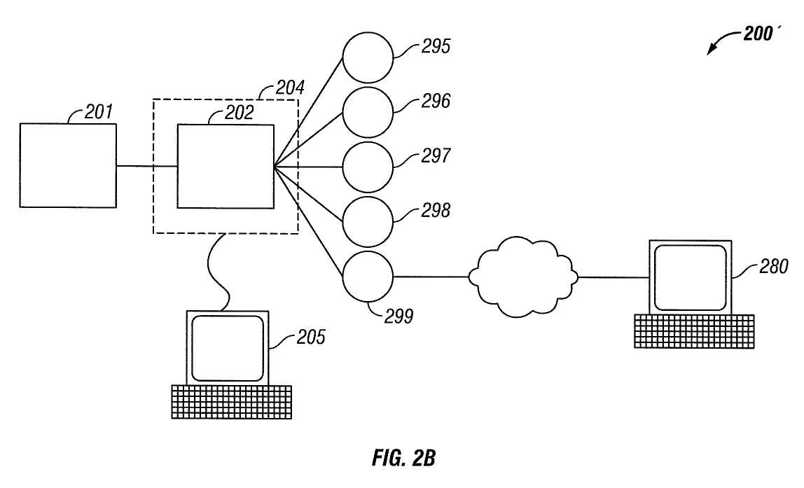

FIG. 2A illustrates a visual representation of an exemplary partnership relationship with a managing partner utilizing the value chain management system according to some embodiments of the present invention. FIG. 2A shows a partnership 200 comprising partners 201, 202, 295, 296, 297, 298, and 299. At least one managing partner 204 is established, wherein the managing partner 204 utilizes a Value Chain Management system 205 comprising management software on a computer readable medium running on a computer system.

According to this particular embodiment, the partner 202 utilizes the Value Chain management system 205 and assumes the responsibility of managing business partner 204. The managing business partner 204 is able to assign Roles to the other partners. As the roles are fulfilled and content is monetized, the Value Chain Management system 205 tracks which partners are owed what reveue rights based on what role each partner actually fulfilled for each time an advertisement is actually served to and consumed by an audience member.

In a simple example, suppose that partner 202, who has been established as the managing partner 204 uses the Value Chain Management system 205 and assigns partner 201 the Role of content provider/content owner, and assigns the partners 295, 296, 297, 298 and 299 the Role of distributor. Next, the managing partner 204 assigns each partner rights and responsibilities. According to this example, partner 201 is assigned the responsibility of creating certain content and is assigned with the rights to get paid a pre-determined amount every time that content is monetized. Preferably, the managing partner 204 and partner 201 have a previously negotiated contract and the managing partner 204 memorializes the terms of the contract into the Value Chain Management system 205.

Likewise, managing partner 204 assigns the partners 295, 296, 297, 298 and 299 with the Role of distributor. Those with the Role of distributor gain access to content from a content owner and is given the right to display that content. Furthermore, the managing partner 204 assigns one or more of the partners 201, 295, 296, 297, 298, 299 or itself, 202 with the right to sell advertising for the content.

Within this particular partnership, suppose that partner 201 provides a digital video clip, partner 202 sells advertising to sponsor and displays the sponsor's ad alongside the clip, and partner 299 distributes the content to a user. The Value Chain Management system 205 tracks these transactions and distributes the rights to get paid a share of the advertising revenue according to the predetermined negotiations between the partners 201, 202 and 299. According to the invention, the Value Chain Management system is configured to be dynamic and flexible. FIG. 2B illustrates a business partnership 200′ according to some embodiments of the invention. Business partnership 200′ is the same partnership 200 as shown in FIG. 2A after partner 299 has evolved to assume a new role.

Suppose now that partner 299, along with having distributor role and capability, now also manages a library of content 280. Partner 299 negotiates with partner 202 to provide content to partner 202 and to receive a percent of the revenue from the sale of advertising against that content. According to the invention, the managing partner 204, in this case partner 202, simply assigns partner 299 with a new role of content owner, as well as maintaining the previous role of distributor.

Along with the assignment of the basic Roles of content owner, distributor and seller of advertisement, the managing partner is also responsible for assigning revenue rights, restrictions and controls over content and advertisements, and the rights to sell advertisements.

For example, the managing partner defines what compensation to due to a partner for fulfilling a particular role. Various compensation models exist depending on what role a partner is fulfilling. For example, the content owner may be compensated by a license fee or by a revenue share of advertising profit. The distributors are compensated with a revenue share for creating an audience and the partner selling the advertising is compensated for monetizing the content. According to the present invention, the managing partner 204 simply enters the details of the contract between partner 202 and 299 in the Value Chain Management system 205.

The Value Chain Management system 205 is now ready to track the monetization rights for both relationships between partners 202 and 299. For example, partner 299 gets paid for distributing content provided by partner 201 (as explained above), but also is paid as a content provider when the content they provide from their library 280 is distributed and consumed by another distributor 295, 296, 297, 298.

As explained in the discussion of FIGS. 2A and 2B, a simple scheme of content creation, distribution and monetization can easily evolve to a more complicated business relationship. However, it is even more complicated in the actual marketplace where a content rights owner may obtain content from hundred or thousands of providers and distribute the content to as many distributors. In turn, those distributors all may desire to resell wholesale content to the content rights owner or may become an original content provider. It is easy to see that the evolving partnership is capable of exponential growth.

Equally easy to see is how laborious the record keeping, tracking, and accounting that must be done to manage such partnerships. Furthermore, each partner would require their own record keeping to ensure accuracy.

Therefore the Value Chain Management system of the present invention provides an extremely useful and inventive edge over traditional accounting and record keeping. This is primarily because with every ad served the Value Chain Management system records which partners were fulfilling each role for that particular advertisement in that particular instance. This ability coupled with the ability to track the partners having multiple roles make the Value Chain Management system extremely useful in the new environment of super syndication and with the environment of heavily interconnected business relationships in the field of digital advertising.

According to the preferred embodiment of the present invention, the actual content is the central item in the ad selection and tracking logic of the Value Chain Management system. The ability to focus on the actual content is more fully described in the co-pending U.S. patent application Ser. No. 11/966,893, filed Dec. 28, 2007 (attorney docket no. FREE0001) entitled A Method and Apparatus for Dynamically Allocating Monetization Rights and Access and Optimizing the Value of Digital Content, which is incorporated herein in its entirety by this reference thereto.

Focusing on the actual content allows the Value Chain Management system to track: which partner created the content and/or owns the content, whether a partner has licensed the content, where the content was actually viewed, and who sold the ad that accompanied the content when it was actually viewed. These events are tracked each and every time an ad is served, thus monetization rights are dynamically apportioned.

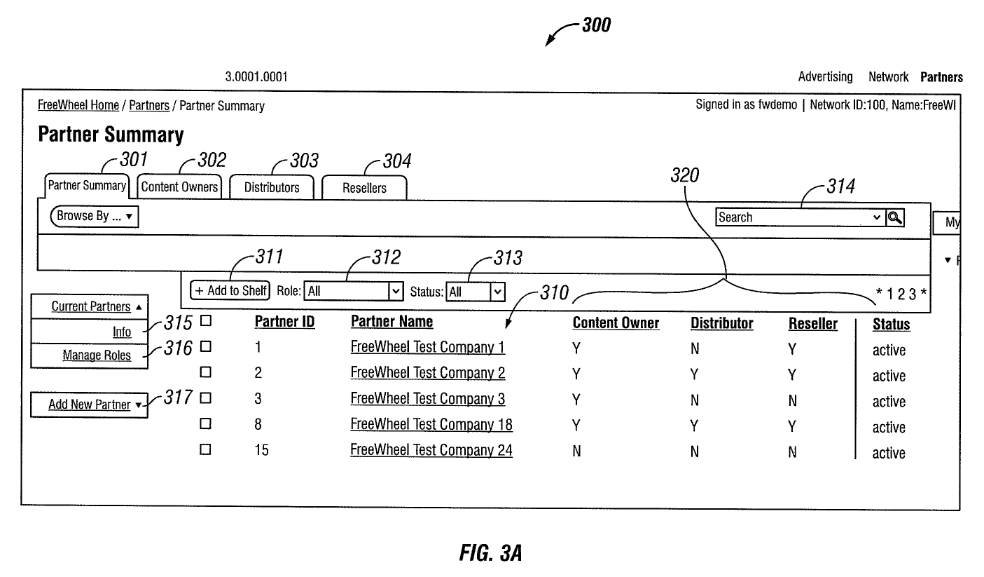

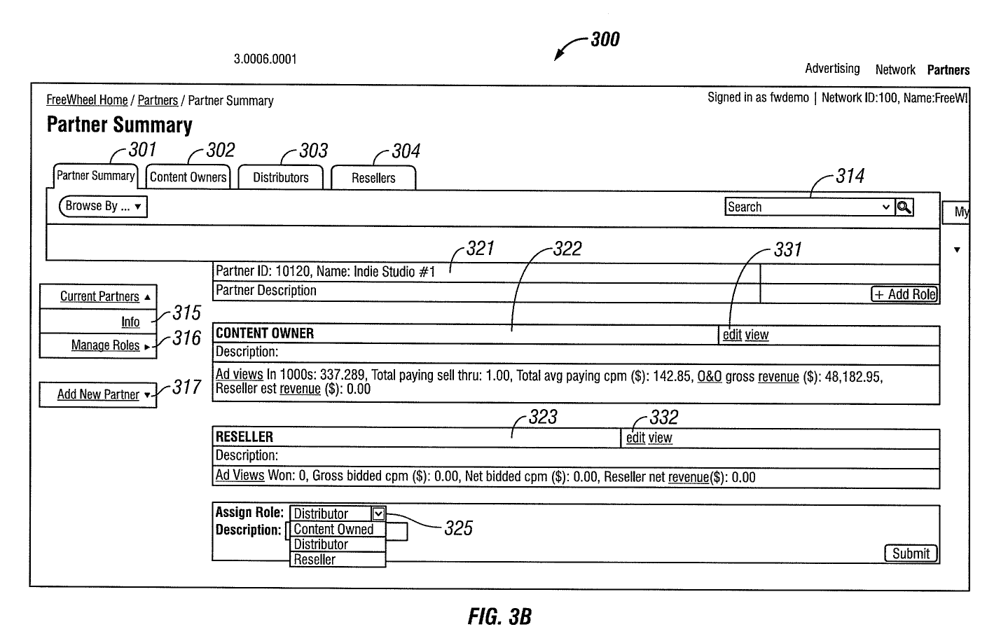

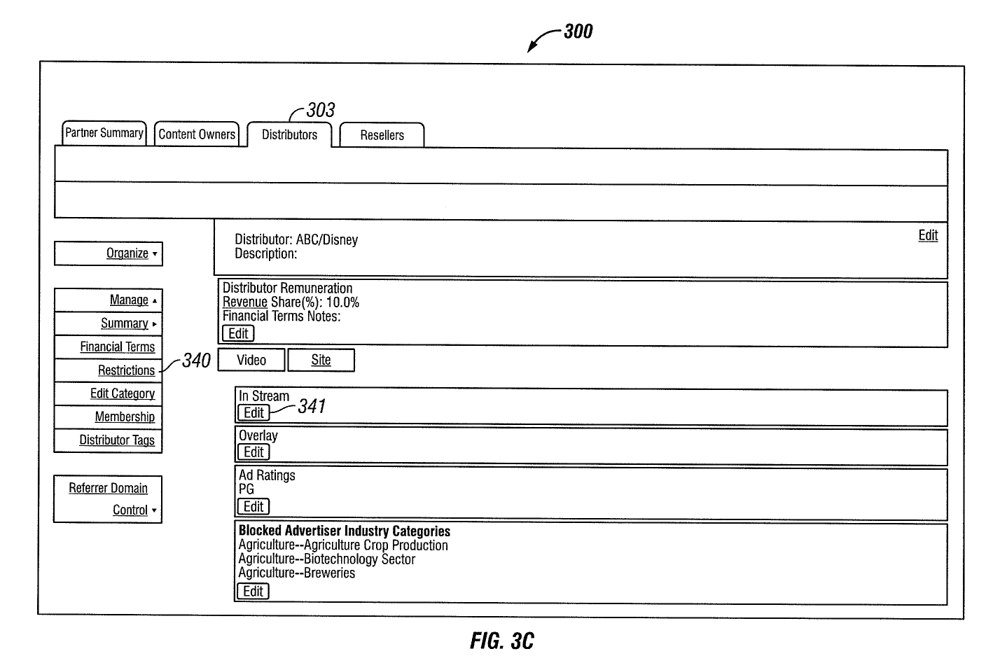

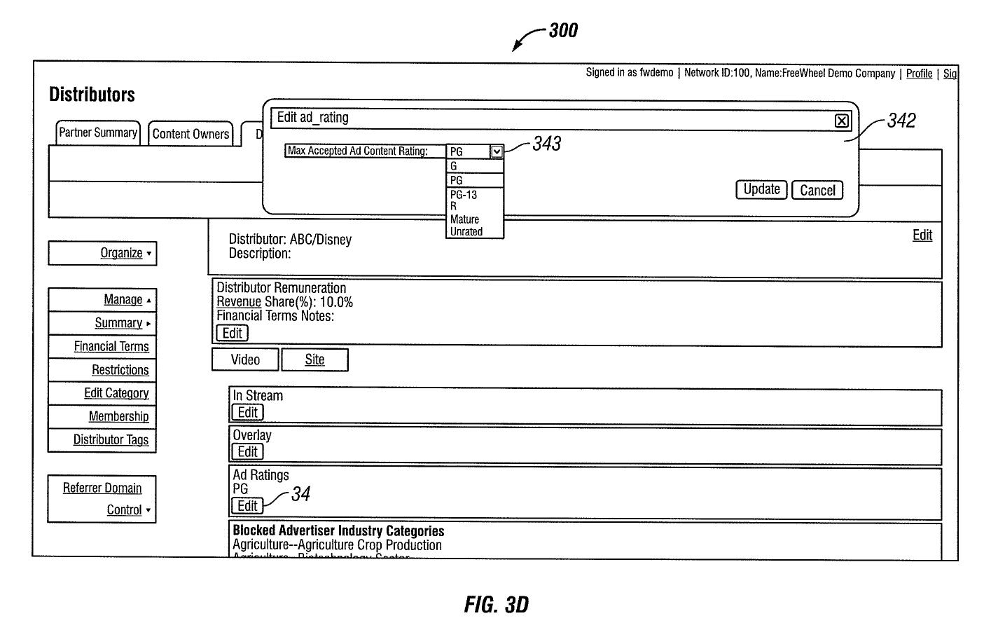

In the preferred embodiment of the present invention, the system of managing a multi-directional advertising value chain comprises a hosted application available to one or more of the business partners. FIG. 3A illustrates an example of a graphical user interface (GUI) 300 provided to a managing partner according to some embodiments of the present invention. As shown, the GUI 300 provides a user with access to various linked tabs 301, 302, 303, 304 for navigating the Value Chain Management system. The tab 301, labeled “Partner Summary” exposes the user to a list of a number of partners 310 and a summary 320 of their current roles.

As explained above, the managing partner is able to manage the partnership with the Value Chain Management system. To this end, various tools 311, 312, 313, 314, 315, 316 and 317 are provided to allow the managing partner to manage the partnership. For example, the managing partner is able to add a new partner via push button 317. Likewise, the managing partner is able to manage the roles of current partners by selecting one or more partners from the list of partners 310 and clicking the link 316 labeled “Manage Roles”.

FIG. 3B illustrates another view of the GUI 300 as experienced by a managing partner according to some embodiments of the present invention. As shown, the GUI is configured to give a user the option of managing the roles of individual partners. For example, in FIG. 3A a partner is identified and described in a text box 321. The current roles assigned to the partner are listed in text boxes 322, 323. As shown, the partner currently has two role assigned to it by the managing partner. Furthermore, the GUI 300 is configured with a drop box 325 to provide the partner with a new role.

As explained above, it is very possible for partner to be fulfilling more than one role in a value chain. To this end, the Value Chain Management system is configured such that the managing partner simply assigns a partner with a new role and sets parameters for that role to dynamically define the rights, responsibilities and controls for that partner. The GUI as shown in FIG. 3B provides the user with all the necessary tools to accomplish these tasks. For example, adding new roles for a partner is accomplished with drop box 325.

Over the course of a partnership, a business negotiation may occur between two or more partners resulting in new contract terms. For instance, the two or more partner may agree on a new scheme of splitting the revenue share upon monetization of content. It is an object of the present invention to account for evolving partnership agreements. As shown in FIG. 3B, once a role is established, the user can easily edit the parameters relevant to that role with links 331, 332.

It is another object of the present invention to provide an accounting to one or more partners of the revenue due to them. To this end, the Value Chain Management system tracks the propagation of digital content as well as the advertisement revenue associated with it. For example, the Value Chain Management system tracks the rights of content owner to receive a share of advertising revenue every time the content they provided is associated with an advertisement being served.

FIG. 3B also illustrates the record keeping function of the GUI 300 for the Value Chain Management system according to some embodiments of the present invention. As shown, text box 322 displays information to the user relating to the payment structure for a particular content owner. Furthermore, detailed statistics are displayed relating to instances of actualized ad views and the monetary amount owed to the content owner.

It is yet another object of the invention to provide one or more partner with the ability to define and manage controls over content and the advertising slots within the content as well as any restrictions placed on the actions of the partners. As such, the Value Chain Management system is configured that the managing partner may define restrictions over one or more partners.

In the preferred embodiment of the present invention, the access rights to the advertisement inventory for a digital content asset is allocated to one or more business partner within the partnership. The advertisement inventory may include space in or around the digital asset. For example, digital video content may have an associated advertisement inventory comprising video pre-roll space, mid-roll space, designated space in the video player, designated space on top of the video player, and designated space around the video player. However, although specific examples of the advertisement slot inventory are listed, it will be readily apparent to those having ordinary skill in the art that the present invention may allocate the rights to any advertisement inventory, now known or later developed.

As an example, suppose that a particular partnership authorizes Partner X to distribute digital video content and to sell advertisement space in that content. However, suppose that the partnership agrees that Partner X may only sell advertisements in the pre-roll portion of the digital video to be displayed prior to a digital video clip and in the corner of the video clip. Using the Value Chain Management system, the managing partner is able to dynamically define the relevant restrictions over the content.

FIG. 3C illustrates an exemplary GUI 300 according to some embodiments of the present invention. As shown, the user has access to a Distributors tab 303. Presented to the user is a summary of the rights and restrictions for one particular partner. The user may also edit the restrictions on a partner's controls with the Restrictions link 340. For example, the managing partner may give the partner the ability to sell pre-roll advertisements and corner logo advertisements.

Also, a particular content owner may wish to restrict the types of advertisement shown with their content. For example, a content provider of children's entertainment may wish to only allow G-rated advertisement when their content is shown. According to the present invention, the managing partner is able to define this Restriction in the Value Chain Management system.

Referring again to FIG. 3C, the summary for a particular distributor indicates that the content distributed may include PG rated advertisements. Using the edit button 341, the managing partner may change the “Ad Ratings” parameters. FIG. 3D illustrates the GUI as presented to a managing partner attempting to change Ad Ratings settings. In response to a user clicking the edit button 341, a dialog box appears. To edit the ad settings, the managing partner simply chooses the appropriate setting from a drop down menu 343 appearing in the dialog box 342.

Although specific examples of rights and restrictions are given, it will be readily apparent to those having ordinary skill in the art having the benefit of this disclosure, that any relevant rights, restrictions, or controls are able to be managed using the Value Chain Management system of the present invention.

As explained above, the present invention fulfills the need for a business partnership management system that is configured to track the partners' actions relating to the various pieces of a content value chain as the value chain dynamically re-compiles into different combinations of partners fulfilling various roles. This is accomplished by managing a multi-directional advertising value chain and effectively managing a very large number of partnerships where each partner can, over time, fulfill any and all of the piece of that value chain simultaneously. The system provides users a method of tracking, accounting, controlling and netting out of compensation for the various pieces of the value chain. Furthermore, the system is flexible enough to ‘add and subtract’ any piece of the advertising value chain as business relationships evolve. In this environment, a system administrator, analyst or any other user is able to observe, track and record what partner is owed what piece of the monetization rights for every instance that an advertisement is served.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

1. A method of managing an evolving online advertising business partnership comprising:
establishing a business partnership comprising one or more business entity for providing one or more role;
establishing a managing business partner from among the one or more business entity to manage the partnership as it evolves, wherein the managing business partner manages the partnership through the steps of:
allocating access rights to a unit of advertisement inventory within an online content asset between the one or more business entities, wherein at least one advertisement is included in the advertisement inventory;
separately determining revenue rights to compensate the one or more entities for both creation of said online content asset and origination of a consumer's consumption of said online content asset, for all relevant entities with each instance of a consumer accessing an online content asset; and
dynamically adjusting the allocation of said access rights and said monetization rights as at least one of the one or more business entities provides a new role;
propagating the online content asset over a network to an audience, wherein a consumer consumes the online content asset and the at least one advertisement such that revenue rights vest; and
tracking a proportionate share of revenue owed to the one or more business entities based the revenue rights.

2. The method of claim 1, wherein the at least one role is selected from among providing at least one online content asset, providing an audience for online content, and selling advertisements associated with online content.

3. The method of claim 2, wherein the business partnership comprises a plurality of business partners, wherein the plurality of partners are coupled to individual nodes in a network architecture.

4. The method of claim 3, further comprising providing Value Chain Management software on a computer in the network, the software configured to perform the steps of managing the partnership as it evolves.

5. The method of claim 4, wherein the Value Chain Management software comprises a graphical user interface (GUI).

6. The method of claim 1, wherein the content asset comprises digital video.

7. The method of claim 1, wherein the step of managing the partnership as it evolves further comprises the step of:
managing one or more restriction for the ad unit inventory, wherein the one or more restriction is established by one or more of the business partners, and wherein the one or more restriction relates to rules regarding the placement of advertisement in the content asset.

8. The method of claim 7, wherein rules are selected from among: rules relating to timing of advertisements, rules relating to the location of advertisements, rules relating to a content rating of an advertisement, rules relating to the owner of the advertisement, and rules relating to the relevance of the advertisement.

9. An apparatus configured for managing an evolving online advertising business partnership comprising:
a network of a communication devices, wherein a plurality of business partners communicate over the network, and wherein each partner from the plurality of business partners performs at least one role in a value chain;
a Value Chain Management (VCM) system operating on the communication device of a managing partner, wherein the managing partner manages the business partnership via VCM system by performing the steps of:
allocating access rights to a unit of advertisement inventory within an online content asset between the plurality of business partners, wherein at least one advertisement is included in the advertisement inventory;
separately determining revenue rights to compensate the one or more plurality of business partners for both creation of said online content asset and origination of a consumer's consumption of said online content asset, for all relevant entities with each instance of a consumer accessing an online content asset; and
dynamically adjusting the allocation of said access rights and said revenue rights as at least one of the plurality of business partners provide a new role; and
a means for propagating the online content asset over the network to an audience, wherein a consumer consumes the online content asset and the at least one advertisement such that revenue rights vest;
wherein the VCM system tracks a proportionate share of revenue owed to the plurality of business partners based the revenue rights.

10. The apparatus of claim 9, wherein the at least one role is selected from among providing at least one online content asset, providing an audience for online content, and selling advertisements associated with online content

11. The apparatus of claim 9, wherein the Value Chain Management (VCM) system operating on the communication device of a managing partner further comprises a graphical user interface (GUI).

12. The apparatus of claim 9, wherein the content asset comprises digital video.

13. The apparatus of claim 9, wherein the managing partner manages the business partnership via VCM system by performing the additional step of
managing one or more restriction for the ad unit inventory, wherein the one or more restriction is established by one or more of the business partners, and wherein the one or more restriction relates to rules regarding the placement of advertisement in the content asset.

14. The apparatus of claim 13, wherein rules are selected from among: rules relating to timing of advertisements, rules relating to the location of advertisements, rules relating to a content rating of an advertisement, rules relating to the owner of the advertisement, and rules relating to the relevance of the advertisement.

15. A computer implemented method of managing an evolving online advertising business partnership comprising:
establishing a business partnership comprising one or more business entity for providing one or more role;
establishing a managing business partner from among the one or more business entity to manage the partnership as it evolves, wherein the managing business partner manages the partnership via a computer program is accessible via a graphical user interface (GUI) and is embedded on a computer readable medium, wherein the program performs the steps of:
allocating access rights to a unit of advertisement inventory within an online content asset between the one or more business entities, wherein at least one advertisement is included in the advertisement inventory;
separately determining revenue rights to compensate the one or more entities for both creation of said online content asset and origination of a consumer's consumption of said online content asset, for all relevant entities with each instance of a consumer accessing an online content asset; and
dynamically adjusting the allocation of said access rights and said revenue rights as at least one of the one or more business entities provides a new role; and
propagating the online content asset over a network to an audience, wherein a consumer consumes the online content asset and the at least one advertisement such that revenue rights vest;
wherein the computer program further tracks a proportionate share of revenue owed to the one or more business entities based the revenue rights.

16. The computer implemented method of claim 15, wherein the at least one role is selected from among providing at least one online content asset, providing an audience for online content, and selling advertisements associated with online content

17. The computer implemented method of claim 15, wherein the business partnership comprises a plurality of business partners, wherein the plurality of partners are coupled to individual nodes in a network architecture.

18. The computer implemented method of claim 1, wherein the content asset comprises digital video.

19. The computer implemented method of claim 1, wherein the step of managing the partnership as it evolves further comprises the step of:
managing one or more restriction for the ad unit inventory, wherein the one or more restriction is established by one or more of the business partners, and wherein the one or more restriction relates to rules regarding the placement of advertisement in the content asset.

20. The computer implemented method of claim 19, wherein rules are selected from among: rules relating to timing of advertisements, rules relating to the location of advertisements, rules relating to a content rating of an advertisement, rules relating to the owner of the advertisement, and rules relating to the relevance of the advertisement.
